(19) United States
(12) Patent Application Publication
(10) Pub. No.: US 2019/0370320 A1
(43) Pub. Date: Dec. 5, 2019

(54) SYSTEM AND METHOD FOR PROVISIONING MULTIPLE FORMS IN AN INTERFACE

(71) Applicant: BANK OF AMERICA CORPORATION, Charlotte, NC (US)

(72) Inventor: Paramdeep Singh Kalra, Dublin, CA (US)

(21) Appl. No.: 16/000,493

(22) Filed: Jun. 5, 2018

(51) Int. Cl. G06F 17/24; G06F 3/0484; G06F 3/0482; G06K 7/14

(52) U.S. Cl. CPC G06F 17/243; G06K 7/1404; G06F 3/0482; G06F 3/0484

(57) ABSTRACT

Embodiments of the present invention provide systems, methods, and computer program products for provisioning multiple forms in an interface. The embodiments achieve this by utilizing a graphical user interface comprising a container, and dynamically populating form templates and corresponding form data entries into the container within the graphical user interface. The systems, methods, and computer program products may provide any number of forms to the user by removing one form from the container and populating the container with a new form and data entries.

### FIELD

The present invention relates to systems, methods, and computer program products for provisioning multiple forms to a user in a graphical user interface.

### BACKGROUND

Graphical user interfaces are frequently provided to users for provide forms comprising data entry fields to a user. Such graphical user interfaces may provide multiple forms to a user by creating separate instances for each form.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages dynamically provisioning forms to a user on an as-requested basis into a container within a graphical user interface. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The present invention may be configured as a system comprising one or more processor components, one or more memory components operatively coupled to the one or more processor components, and computer readable instructions stored on the one or more memory components and configured to cause the one or more process components to proceed according to embodiments as described herein. Alternatively, the invention may be configured as a method following the steps according to embodiments as described herein. In still further embodiments, the invention may be configured as a computer program product configured according to embodiments as described herein. For simplicity, this background section will focus on embodiments of the present invention as a system, though it should be understood that both the method and computer program product embodiments would perform similarly in their respective environments.

The system may be configured to initiate presentation of a graphical user interface to a device of the user, the graphical user interface comprising a container to dynamically display forms to the device of the user. The system may then receive a request from a user, via the graphical user interface, to retrieve a first form. The system may then retrieve from a first database a template for the first form, wherein the template comprises a plurality of data fields and retrieve from a second database a plurality of data entries corresponding to the plurality of data fields. The system may then display the first form in the container in the graphical user interface, wherein displaying the first form comprises dynamically populating the plurality of data fields with the plurality of retrieved data entries. The system may then receive a request from the user via the graphical user interface to close the first form. Finally, the system may remove the form from the container in the graphical user interface.

In further or alternative embodiments of the invention, the system may receive a user input to modify at least one of the plurality of data entries in at least one of the plurality of data fields. In such further or alternative embodiments, the system may then store the modified data entry in the second database.

In still further or alternative embodiments of the invention, receiving a request from the user to close the first form comprises receiving a request to retrieve a second form. Further, such embodiments may retrieve from the first database a second template for the second form, wherein the second template comprises a plurality of data fields and also retrieve from the second database a plurality of data entries corresponding to the plurality of data fields comprising the second template. The system may then display the second form in the container in the graphical user interface, wherein displaying the second form comprises dynamically populating the plurality of data fields with the plurality of retrieved data entries.

In further or alternative embodiments of the invention, receiving a request from a user to retrieve a first form comprises receiving a scanned barcode number.

In still further or alternative embodiments of the invention, the plurality of data fields may comprise at least one of a text data field, a drop down menu data field, a numerical entry data field, and a selection button data field.

In still further or alternative embodiments of the invention, the system may further comprise receiving a request from the user to lock the first form, wherein locking the first form comprises putting a restriction on the first form such that a user may no longer modify the data entries in the first form.

### BRIEF DESCRIPTION OF THE DRAWINGS

FIG. 1 is a system diagram illustrating an exemplary embodiment of the invention.

FIG. 2 is a flowchart depicting a process flow according to embodiments of the present invention.

FIG. 3 is a sample graphical user interface depicting one of a plurality of forms according to embodiments of the present invention.

FIG. 4 is a sample graphical user interface depicting one of a plurality of forms according to embodiments of the present invention.

FIG. 5 is a sample graphical user interface depicting one of a plurality of forms according to embodiments of the present invention.

FIG. 6 is a sample graphical user interface depicting one of a plurality of forms according to embodiments of the present invention.

FIG. 7 is a sample graphical user interface depicting one of a plurality of forms according to embodiments of the present invention.

FIG. 8 is a sample graphical user interface depicting one of a plurality of forms according to embodiments of the present invention.

FIG. 9 is a sample graphical user interface depicting one of a plurality of forms according to embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shows. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

As described in greater detail with reference to the figures below, embodiments of the invention as described herein are systems, methods and computer program products for provisioning multiple forms in a user interface. Generally speaking, provisioning multiple forms in a user interface requires a tremendous amount of processor and memory usage on a user computing device, as the data and template for each form must be stored locally to permit the user access. The present invention discloses systems, methods and computer program products that solve this problem by dynamically provisioning forms to a user on an as-requested basis into a container within a graphical user interface. The user is therefore unaware that the multiple forms are not locally available, as the container within the graphical user interface is used to dynamically render the same to the user only as needed. Accordingly, the memory and processor demands on the user computing device are greatly reduced, allowing the user to work in multiple forms more efficiently.

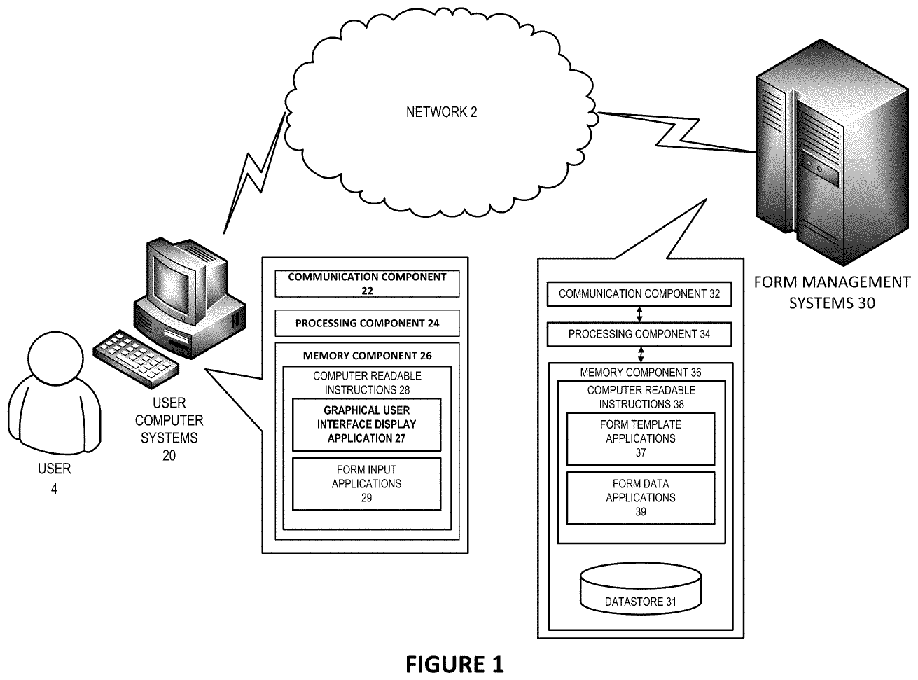

Now reference will be made to the figures in order to better describe aspects of embodiments of the invention. FIG. 1 is a system diagram illustrating an exemplary environment in which the systems, methods and computer program products may be deployed. As illustrated in FIG. 1, exemplary embodiments of the invention will feature one or more user computer systems 20, a network 2, and one or more form management systems 30. The user computer systems may be a laptop, desktop, tablet, mobile phone, or any other computing device. The user computer systems 20 are operatively connected to the one or more form management systems 30 over the network 2. The connection may be any viable communications means that allow the user computer systems 20 to communicate with the one or more form management systems 30, including physical connections such as Ethernet, or by wireless means such as Wi-Fi, Bluetooth, 4G LTE, or other known wireless communication techniques. In some embodiments, communications transmitted over the network may be encrypted.

As shown in FIG. 1, the User Computer Systems 20 comprise a communication component 22, a processing component 24, and a memory component 26. The memory component 26 stores computer readable instructions 28 that cause the processing component 24 to run the graphical user interface display application 27 and the form input applications 29.

The form management systems 30 also comprise a communication component 32, a processing component 34, and a memory component 36. The memory component 36 stores computer readable instructs 38 that cause the processing component 34 to run the form template applications 37 and the form data applications 39. The form management systems 30 further comprise at least one datastore 31.

In a typical embodiment, a user 4 will log on to the user computer systems 20 and launch the graphical user interface display application 27. The user will be presented with a graphical user interface allowing the user to view and input or alter data in a plurality of forms. As will be discussed in more detailed herein, the graphical user interface display application 27 will function by creating a graphical user interface to the user that comprises a container window. The container window will populate with the various forms comprising data entry fields and other form elements as required for each form. By using the container window, multiple forms may be rendered in and out of the container at reduced memory and processor usage as compared to previous systems. The graphical user interface display application 27 will also work in connection with the form input applications 29 to allow the user to input or alter data into the various forms.

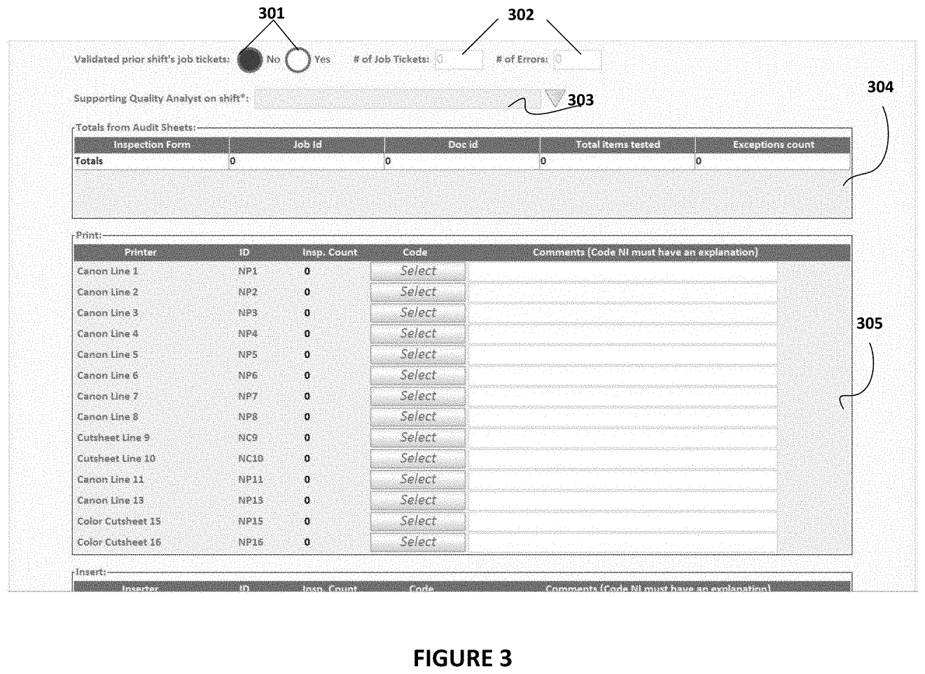

When the user 4 logs onto the graphical user interface display application 27, the user may request to view or edit a particular form. Accordingly, the user 4 may request to view or edit a particular form through the graphical user interface application 27. When the user 4 does so, the user computer systems 20 will communicate that request using the communication component 22 over the network 2 to the form management systems 30. Once the request is received by the form management system 30 via its communication component 32, the form management system will retrieve the requested form to communicate the form back to the user computer systems 20. In a typical embodiment, the form management systems 30 will need to retrieve both a form template and form data via the form template applications 37 and the form data applications 39, respectively. The form template comprises the data entry fields and layouts of the various forms the user 4 wishes to access. The types of forms a user may access will be discussed in more detail with reference to FIGS. 3-9. The form data comprises the data that populates the data fields for the various forms. Both form data and form templates may be stored in the datastore 31.

Once the form management systems 30 have retrieved the form template and form data via the respective applications, the form management systems 30 will communicate the form template and form data over the network 2 back to the user computer systems 20. Once the user computer systems 20 receives the form template and form data from the form management systems 30, the user computer systems 20 will display the form template and the form data in the graphical user interface. As alluded to earlier, displaying the form template comprises displaying the form template in a container within the graphical user interface. In this regard, the entire graphical user interface does not have to launch each time a new form is requested. Instead, each new form simply needs to be populated in the container window and new forms may be quickly rendered in and out of the container at low memory and processor usage.

Once the graphical user interface on the user computer systems 20 has displayed the form template and the form data to the user 4, the user can begin to manipulate the form as desired. For example, the user 4 may wish to update the form data for a certain entry. If the requested form is related to a particular work order, the user 4 may wish to update the status of the work from “In Progress” to “Complete.” Once the user 4 makes such changes, the communication component 22 on the user computer systems 20 will communicate that change to the form data over the network 2 to the form management systems 30. The form management systems 30 will then update, via the form data applications 39, the form data for that particular entry. Now, when a user 4 wishes to retrieve the same form, the form will display “Complete” to reflect the change in status as updated by the previous user 4.

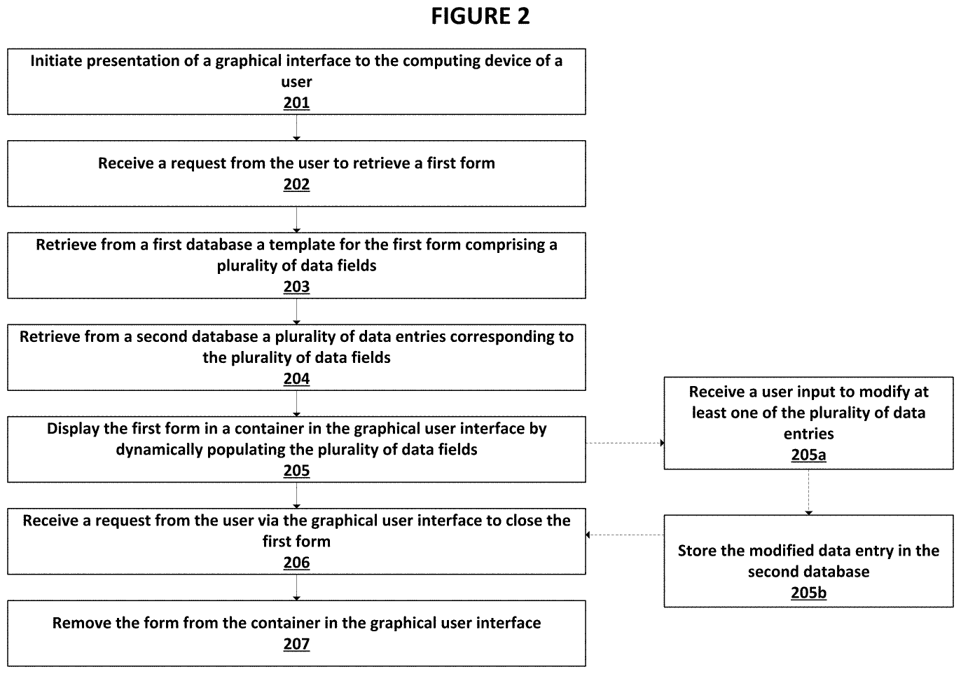

FIG. 2 is a flowchart illustrating a process flow according to exemplary embodiments of the invention. As depicted in FIG. 2 at block 201, the systems, methods, and computer program products as contemplated herein typically begin by initiating presentation of a graphical user interface to the computing device a user. In some embodiments, this will occur at the request of a user; for example, by launching a program from a user's desktop computer. Alternatively, a user may be presented with the graphical user interface automatically upon the occurrence of certain events; such as if form data is preprogrammed to expire at a certain date and time. In any event, the user 4 is presented with a graphical user interface on the user computer systems 20 as described above.

At block 202, the system will receive a request from the user 4 to retrieve a first form. In this regard, the system receives the request based on a certain user action or input. For example, the user may select a form from a drop down menu. Alternatively, the user may input a file name or operate a search for a particular form. In such an instance, the user 4 may desire to find a form relevant to a particular work order. The user 4 could simply operate a search for the work order number associated with that work order. The user's request to retrieve the particular form will be sent over the network 2 to the form management systems 30.

At block 203, the system retrieves from a first database a template for the first form comprising a plurality of data fields. In some embodiments, the first database may be an embedded database, allowing for quick access and rendering of the form templates. In alternative embodiments, the database may be located at an offsite facility and accessed over a network. In either embodiment, the form management system retrieves the form template stored in its datastores to display to the user. The form templates will be described in greater detail with respect to FIGS. 3 through 9. Typically, a form template will include the different types of data entries that are relevant to that particular type of form. For example, for example, a typical form may include text entry fields, drop down menus, numerical entry, data selection buttons, and the like. The form template will also include layout information, which provides instructions to the graphical user interface of the user computer systems 20 on how the various data entries will be displayed on the user computer systems 20.

At block 204, the system retrieves from a second database a plurality of data entries corresponding to the plurality of data fields retrieved at block 203. It should be understood that the second database may not be physically distinct from the first database comprising the form template information. However, in some embodiments it may be preferred to store the relevant form data separate from form template information, for security or other reasons. In either event, the system will retrieve all available data relevant to the particular form requested by the user 4. In some instances, only some of the data fields will be populated, as there is no corresponding data entry. For example, data fields corresponding to data entries may not yet have been created, as the form is not complete. In such a case, only the data fields that have data to be retrieved will be populated. The remaining data fields will be left black in the graphical user interface, to be filled in with data entries by the user 4.

At block 205, the system display the first form in a container in the graphical user interface by dynamically populating the plurality of data fields. In this regard, the system uses the form template retrieved at block 203 to properly display the form data fields in the container in the graphical user interface. As noted above, using the container in the graphical user interface reduces the memory and processing demands on the computer user systems 20. As the data entries are retrieved at block 204, such data entries are communicated back to the user computer systems 20 and dynamically populated into the corresponding data fields in the form. As such, the user 4 is presented with the form template and it is populated with all relevant data, all at the user's request to retrieve the first form.

In some instances, the user 4 may wish to simply view the form, so as to ascertain certain information regarding the data's contents. For example, if the form is related to a particular work order, the user may wish to simply view the status of such work order. In such a case, the user may not wish to make any changes to the form data. However, in some instances, the user 4 may wish to modify certain data entries within the form, such as, in the case of the work order form, to change the status of the work order if the user 4 knows that the work order has changed status. In this instance, the system will go to block 205a, where the system receives a user input to modify at least one of the plurality of data entries in the form.

When the user modifies at least one of the plurality of data entries in block 205a, the system will then store the modified data entry in the second database, as shown in block 205b. Thus, when the user 4 or a different user wishes to access the form at a later instance, the system will retrieve the modified data from the second database at block 204. This allows users to modify and store up to date information all within the system.

At block 206, the system receives a request from the user via the graphical user interface to close the first form. The user may request to close the first form either because they have viewed and obtained all the necessary information from such form, or because they have completed modifications to the plurality of data entries as necessary. Further, the user 4 may request to close the form by clicking an icon or similar button to close the form, or by requesting the system to retrieve a second form for the user to use.

Finally, at block 207, the system removes the form from the container in the graphical user interface, thereby allowing, if desired, another form to be quickly and efficiently rendered into the container. The user 4 may then be presented with an additional form, if so requested at block 206. In such an instance, the process flow will resume at block 202, with the request of a second form. Alternatively, the user 4 may choose to close the graphical user interface in its entirety, at which point the system will cease operating until the user 4 initiates the process again at block 201.

FIGS. 3 through 9 depict sample forms in accordance with embodiments of the present invention. As will be described in more detail with respect to those Figures, the forms depicted would be displayed to the user 4 in the container within the graphical user interface as described above.

FIG. 3 depicts a sample form related to a job performance audit to be conducted following a job shift. As shown in FIG. 3, there are several different data fields where a user 4 may input information relevant to the job performance audit. The form includes yes/no buttons 301 for the user to input whether the prior shift's job tickets were validated. Similarly, there are numerical data fields 302 corresponding to the number of job tickets and the number of errors. Additionally, there is text entry data field for the user to input the supporting quality analyst on shift. The triangle to the right of the text entry data field 303 may indicate a drop down menu, where the user can fill in the text entry data field 303 from a prepopulated list of supporting quality analysts, or may type in a text entry not found on the prepopulated list. The form additionally features a summary box 304, where the sum totals of the data entries discussed above may be shown, both for the current form and for other forms the user 4 may have already completed. Finally, the form contains a print display 305, where the user can select various printers and provide comments related to the same in the text entry fields corresponding to each printer.

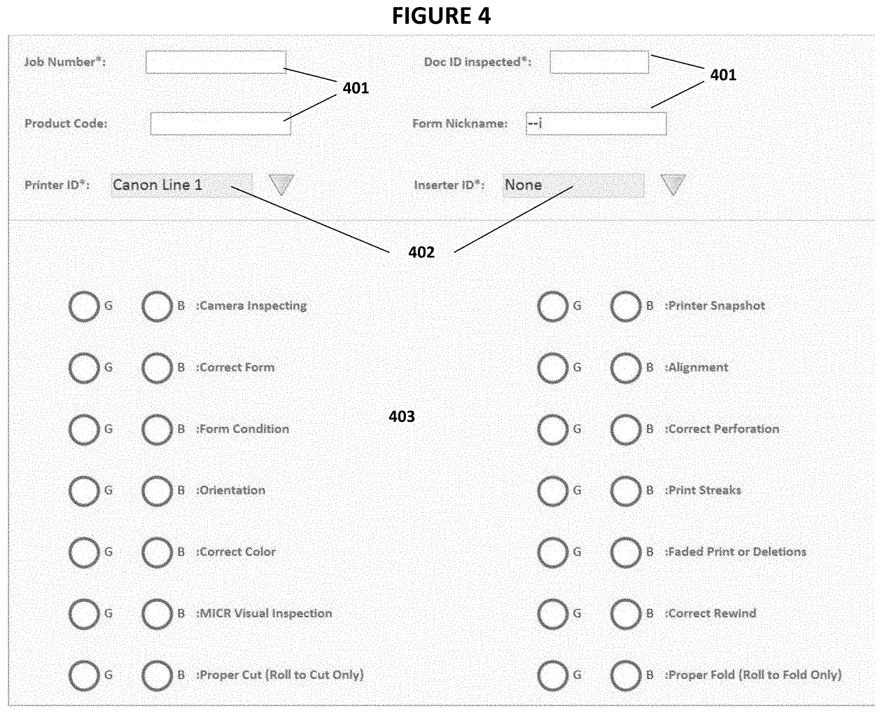

FIG. 4 depicts additional form elements that may be included in another job performance audit. As shown in FIG. 4, there are text entry data fields 401 for a Job Number, Doc Id inspected, Product Code, and Form Nickname. Certain data fields as shown in FIG. 4 are accompanied by an asterisk, indicating that they are required fields. Accordingly, the user 4 must enter a value for these data fields before closing the form. The system will prevent the user 4 from closing out the form unless values have been entered for such data entries. FIG. 4 also shows additional text entry fields that are accompanied by a drop down menu, as discussed above with respect to FIG. 3. Finally, FIG. 4 contains a field of review buttons 403 where a user 4 can indicate the relative condition of the various devices that may have been reviewed. As shown in FIG. 4, the user may select either G or B for the various entries. It will be understand that other forms may contain more comprehensive review buttons, such as on a 1 to 5 scale.

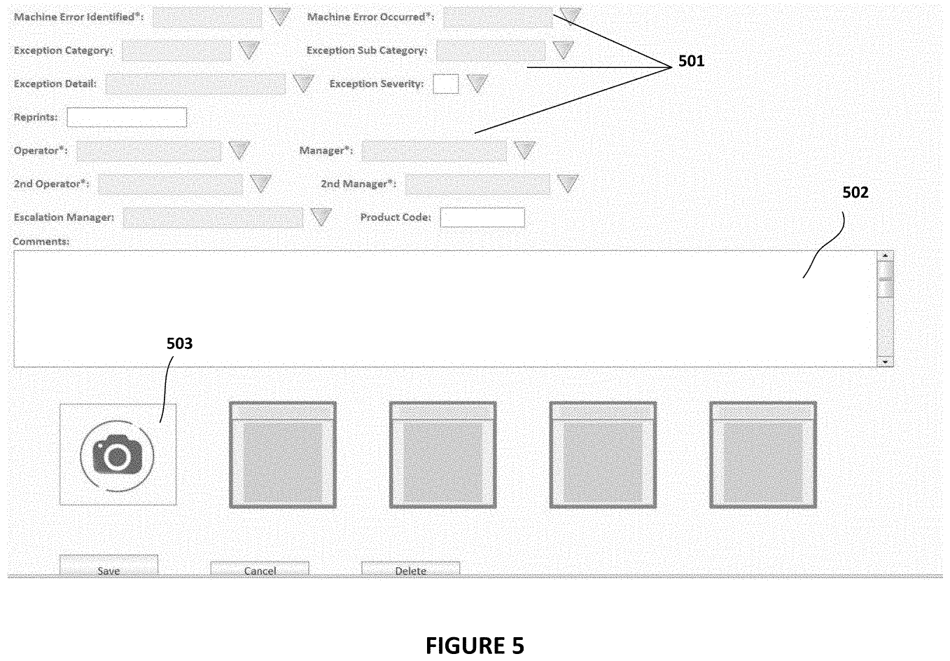

FIG. 5 depicts additional form elements. As shown in FIG. 5, there are several text data entry fields with accompanying drop down menus 501, similar to those described with respect to FIGS. 3 and 4. Also shown in FIG. 5 is a comment box 502, where a user can input long-form comments regarding the subject of the particular form. Near the bottom of the form depicted in FIG. 5 are additional image upload tools 503 where a user 4 may upload camera images or other images to accompany the data entries in the rest of the form.

Lastly, FIG. 5 depicts a save button 504, a cancel button 505, and a delete button 506. The save button allows the user to save the data entries submitted into the form. As discussed earlier, once the data is saved, it will be communicated back to the form management system, where it will be saved in the corresponding datastore so it can be retrieved by a later user. The cancel button 505 allows a user to cancel all of the data entries they have made for that particular form. The delete button 506 allows the user 4 to delete the form. This may be desired by the user 4 if the form is a duplicate, or if the data stored in the form is no longer needed by the user 4 or any future users.

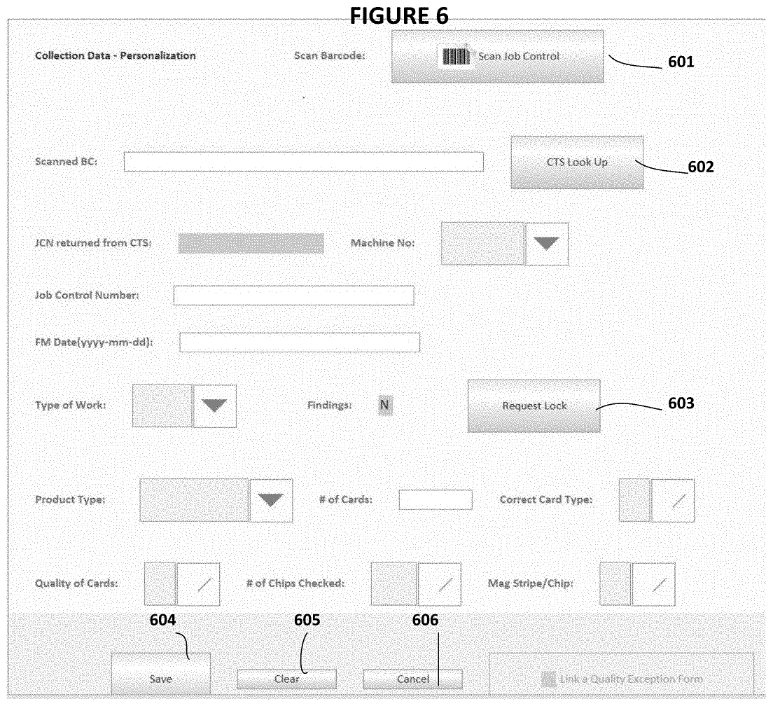

FIG. 6 depicts a form with alternative input methods than those described with respect to FIGS. 3 through 5. As depicted in FIG. 6, a user 4 may use the bar code scan button 601 to recall a particular job. Accordingly, the user may activate an attached camera (e.g., a webcam, cell phone camera, or other camera) to scan a barcode on a particular physical document, machine, or other object where a barcode may exist. Once the user scans the barcode, some of the data in the form may automatically populate, including text fields that include a job number or date. Alternatively, the user may use the CTS look up button 602 to automatically populate data entry fields based on the CTS number. FIG. 6 also shows a request lock button 603, where a user 4 may request to lock certain data entry fields for that particular form. In this sense, the user 4 may lock the form to prevent other users from altering the data entry fields contained therein. Finally, FIG. 6 depicts the save button 604, clear button 605, and cancel button 606, which function similarly to those described above.

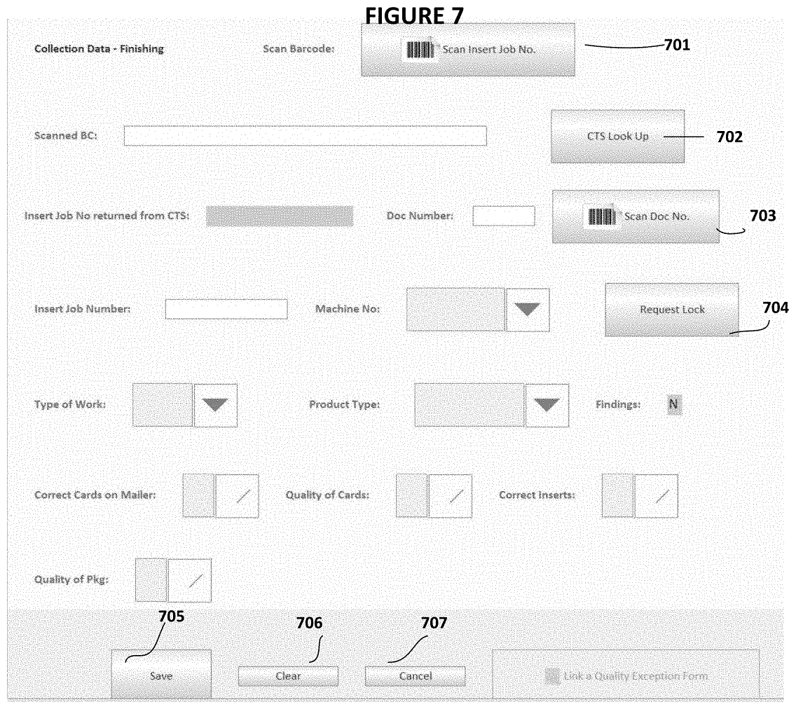

FIG. 7 depicts a form very similar to that described above with respect to FIG. 6. FIG. 7 shows the scan insert job no. button 701, the CTS look up button 702, a request lock button 704, a save button 705, a clear button 706, and a cancel button 707. These data entry fields and buttons function in substantially the same manner as previously described. Also shown in FIG. 7 is the scan doc no. 703, in which a user 4 may use an attached camera to scan a document number, as opposed to a bar code as described previously. In this sense, the system can incorporate optical character recognition technology to “read” a document number scanned in by the user. The system can then identify the relevant job number and populate the data entry fields accordingly.

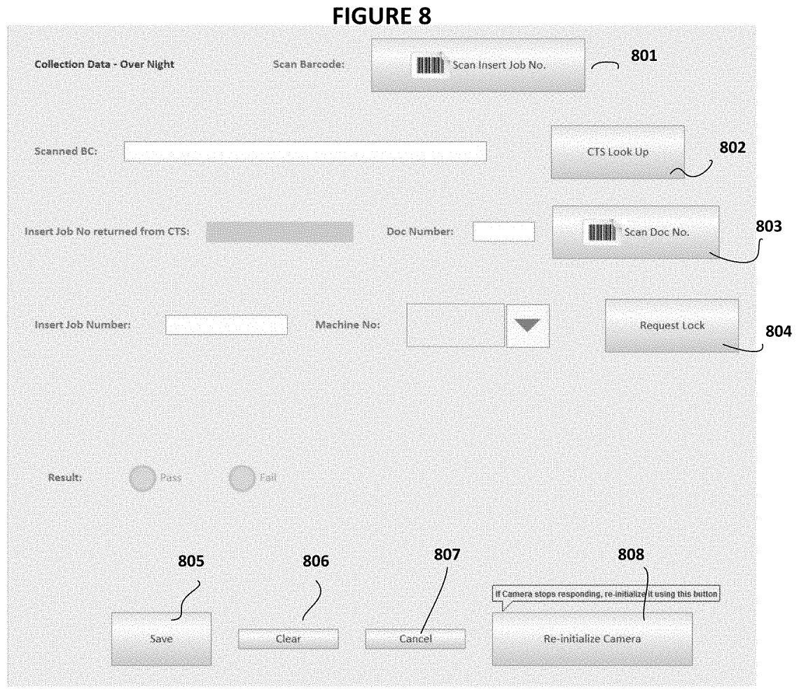

FIG. 8 depicts another embodiment of a form according to the present invention. FIG. 8 shows the scan insert job no. button 801, the CTS look up button 802, a scan Doc. No. button 803, a request lock button 804, a save button 705, a clear button 806, and a cancel button 807. These features operate in substantially the same manner as previously described herein. FIG. 8 also depicts a Re-initialize Camera button 808. The Re-initialize Camera button 808 controls the attached camera, webcam, or other image capture device attached to the user computer systems 20 and used for scanning job numbers or document numbers as previously described.

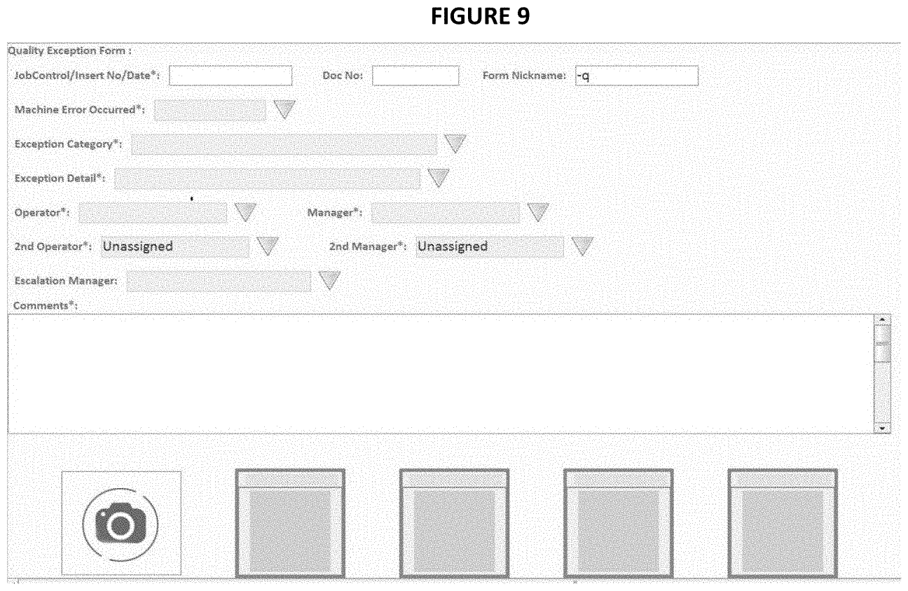

FIG. 9 depicts an additional form according to embodiments of the present invention. As shown in FIG. 9, there are several text fields, comment boxes, and image upload tools similar to those described above.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for providing a plurality of forms to a user in a graphical user interface, the system comprising:
one or more processor components;
one or more memory components operatively coupled to the one or more processor components;
computer-readable instructions stored on the one or more memory components and configured to cause the one or more processors components to:
initiate presentation of a graphical user interface to a device of the user, the graphical user interface comprising a container to dynamically display forms to the device of the user;
receive a request from a user, via the graphical user interface, to retrieve a first form;
retrieve from a first database a template for the first form, wherein the template comprises a plurality of data fields;
retrieve from a second database a plurality of data entries corresponding to the plurality of data fields;
display the first form in the container in the graphical user interface, wherein displaying the first form comprises dynamically populating the plurality of data fields with the plurality of retrieved data entries;
receive a request from the user via the graphical user interface to close the first form;
remove the form from the container in the graphical user interface.

2. The system of claim 1, the system further comprising:
receive a user input to modify at least one of the plurality of data entries in at least one of the plurality of data fields;
store the modified data entry in the second database.

3. The system of claim 1, wherein receiving a request from the user to close the first form comprises receiving a request to retrieve a second form, the system further comprising:
retrieve from the first database a second template for the second form, wherein the second template comprises a plurality of data fields;
retrieve from the second database a plurality of data entries corresponding to the plurality of data fields comprising the second template;
display the second form in the container in the graphical user interface, wherein displaying the second form comprises dynamically populating the plurality of data fields with the plurality of retrieved data entries.

4. The system of claim 1, wherein receiving a request from a user to retrieve a first form comprises receiving a scanned barcode number.

5. The system of claim 1, wherein the plurality of data fields comprises at least one of a text data field, a drop down menu data field, a numerical entry data field, and a selection button data field.

6. The system of claim 1, wherein the system further comprises receiving a request from the user to lock the first form, wherein locking the first form comprises putting a restriction on the first form such that a user may no longer modify the data entries in the first form.

7. A method for providing a plurality of forms to a user in a graphical user interface, the system comprising:
initiating presentation of a graphical user interface to a device of the user, the graphical user interface comprising a container to dynamically display forms to the device of the user;
receiving a request from a user, via the graphical user interface, to retrieve a first form;
retrieving from a first database a template for the first form, wherein the template comprises a plurality of data fields;
retrieving from a second database a plurality of data entries corresponding to the plurality of data fields;
displaying the first form in the container in the graphical user interface, wherein displaying the first form comprises dynamically populating the plurality of data fields with the plurality of retrieved data entries;
receiving a request from the user via the graphical user interface to close the first form;
removing the form from the container in the graphical user interface.

8. The method of claim 7, the method further comprising:
receiving a user input to modify at least one of the plurality of data entries in at least one of the plurality of data fields;
storing the modified data entry in the second database.

9. The method of claim 7, wherein receiving a request from the user to close the first form comprises receiving a request to retrieve a second form, the system further comprising:
retrieving from the first database a second template for the second form, wherein the second template comprises a plurality of data fields;
retrieving from the second database a plurality of data entries corresponding to the plurality of data fields comprising the second template;
displaying the second form in the container in the graphical user interface, wherein displaying the second form comprises dynamically populating the plurality of data fields with the plurality of retrieved data entries.

10. The method of claim 7, wherein receiving a request from a user to retrieve a first form comprises receiving a scanned barcode number.

11. The method of claim 7, wherein the plurality of data fields comprises at least one of a text data field, a drop down menu data field, a numerical entry data field, and a selection button data field.

12. The method of claim 7, wherein the method further comprises receiving a request from the user to lock the first form, wherein locking the first form comprises putting a restriction on the first form such that a user may no longer modify the data entries in the first form.

13. A computer program product for providing a plurality of forms to a user in a graphical user interface, the computer program product comprising at least one non-transitory computer readable medium comprising computer readable instruction, the instructions comprising instructions for:
initiating presentation of a graphical user interface to a device of the user, the graphical user interface comprising a container to dynamically display forms to the device of the user;
receiving a request from a user, via the graphical user interface, to retrieve a first form;
retrieving from a first database a template for the first form, wherein the template comprises a plurality of data fields;
retrieving from a second database a plurality of data entries corresponding to the plurality of data fields;
displaying the first form in the container in the graphical user interface, wherein displaying the first form comprises dynamically populating the plurality of data fields with the plurality of retrieved data entries;
receiving a request from the user via the graphical user interface to close the first form;
removing the form from the container in the graphical user interface.

14. The computer program product of claim 13, wherein the computer readable instructions further comprise instructions for:
receiving a user input to modify at least one of the plurality of data entries in at least one of the plurality of data fields;
storing the modified data entry in the second database.

15. The computer program product of claim 13, wherein receiving a request from the user to close the first form comprises receiving a request to retrieve a second form, wherein the computer readable instructions further comprise instructions for:
retrieve from the first database a second template for the second form, wherein the second template comprises a plurality of data fields;
retrieve from the second database a plurality of data entries corresponding to the plurality of data fields comprising the second template;
display the second form in the container in the graphical user interface, wherein displaying the second form comprises dynamically populating the plurality of data fields with the plurality of retrieved data entries.

16. The computer program product of claim 13, wherein receiving a request from a user to retrieve a first form comprises receiving a scanned barcode number.

17. The computer program product of claim 1, wherein the plurality of data fields comprises at least one of a text data field, a drop down menu data field, a numerical entry data field, and a selection button data field.

18. The computer program product of claim 1, wherein the computer program product further comprises instructions for receiving a request from the user to lock the first form, wherein locking the first form comprises putting a restriction on the first form such that a user may no longer modify the data entries in the first form.
